(19) United States
(12) Patent Application Publication
(10) Pub. No.: US 2002/0109594 A1
(43) Pub. Date: Aug. 15, 2002

(54) Security systems

(76) Inventors: Tim Chapman, Hamilton (CA); Michael Higgins, Hamilton (CA)

Correspondence Address: Tim Chapman, 1367 Main ST E., Hamilton, ON, L8K 1B8, CA

(21) Appl. No.: 09/781,202

(22) Filed: Feb. 12, 2001

(51) Int. Cl. G08B 13/14

(52) U.S. Cl. 340/571; 340/568.1

(57) ABSTRACT

Battery operated security system for valuable object/equipment protection, involving motion sensing means to act on latching means to activate a sound emitting alarm which can be deactivated only by a security key opening the latched circuit—all involved elements of the said security system being affixed to the valuable object/equipment or objects rigidly associated with it like cases or the like.

### BACKGROUND OF THE INVENTION

1. Field of the invention

This invention relates to a new class of security systems dedicated to the protection of valuable/classified objects or equipment against theft or unauthorized moving; the proposed invention relates to a new class of security systems for valuable/classified objects or equipment, the said security systems being sensitive to the motion of the said objects or equipment.

2. Prior Art

The known protection systems for valuable objects are based on capacitive, photoelectric, acoustic, radar or combined sensors, able to sense the presence of the unauthorized human body or bodies around the protected objects; also there are known protection systems for valuable objects based on video cameras/machine vision, image interpretation and processing.

The disadvantages of the known protection systems are that they are generally complex, involving wiring and different wired accessories, making easy for an intruder to disconnect them or to make them invalid; also they involve complex setup and sometime complex software; also they are focussing on interpreting the movements around the valuable object or sensing the movements of the valuable objects by means of exterior field variation like light, sound, magnetic, capacitive, etc.; when the field is perturbed, then an exterior alarm is activated; usually this alarm can be disconnected, or if the perpetrators act fast they simply ignore it moving fast with the stolen object beyond the reach of the enforcement structures.

### ESSENTIAL SUMMARY OF THE INVENTION

The above disadvantages are eliminated by the proposed invention in which the security system is involving/comprising in essence the following:

a valuable object/equipment;

an electric battery having a plus terminal and a minus terminal;

an alarm board with high intensity sound emitting means having a plus connecting terminal and a minus connecting terminal;

whereby the electric battery being compatible in terms of voltage with the alarm board;

a resistor having a front end terminal and a rear end terminal;

a normal open contact having a front end terminal and a rear end terminal, this normal open contact being hereinafter called the normal open motion detecting contact, this normal open contact being associated with means to detect the motion of the valuable object/equipment so that when the motion is happening the normal open contact is closing;

electrically/electronically latching means able to latch or to keep closed a circuit if a latching signal is applied to it, having a latching command terminal hereinafter called gate and two terminals which are latched together to permit the passing of electric current, one being named hereinafter cathode and the other being named hereinafter anode;

a normally open, manually operated spring pressed reset button having a front end terminal and a back end terminal;

a normally closed switch able to be manually operated/opened by a dedicated security key and having 2 terminals, one in the front and one in the back;

whereby the plus terminal of the battery being connected to the plus terminal of the alarm board with the sound emitting means;

whereby the front terminal of the resistor being connected with the plus terminal of the battery and the back terminal of the resistor being connected with the front end terminal of the means to detect the motion of the valuable object;

whereby the back terminal of the means to detect the motion of the valuable object being connected with the gate terminal of the latching means;

whereby the anode terminal of the latching means being connected with the negative terminal of the alarm board and with the front terminal of the reset button,

whereby the cathode terminal of the latching means being connected with the back terminal of the reset button and with the front terminal of the reset key;

whereby the back terminal of the reset key being connected with the minus terminal of the battery;

whereby all the above comprised or involved objects or at least the motion sensing means being rigidly affixed to the valuable object or structures rigidly associated with it like protection cases or the like.

The way of operation of the above described class of security systems is as follows.

In the moment when the motion sensing means is detecting the motion of the valuable object, then the normally open contact associated with the motion sensing means is closed and a latching signal is given via the gate to the latching circuit making the current to go from cathode to anode in a latching mode—at that moment, the alarm board with sound emitting means will be activated and a piercing noise will be generated—because the system is latched by the latching system; in this way the alarm will sound as long as the battery will last—usually cca 9 hours—enough to deter any perpetrator to go away with the valuable object or equipment; the system could be delatched when the security key is activated to open its normally closed contact; at that moment the system is practically rearmed for the next motion occurrence; the normally open reset button is used to check the battery and the system in general.

### BRIEF DESCRIPTION OF THE DRAWING ILLUSTRATING AN EXAMPLE OF THE INVENTION

These and other objects, features and advantages of the invention will be better understood by reading the following detailed description in conjunction with the attached drawing, in which:

FIG. 1 is a schematic diagram of the example application of the invention.

### DETAILED DESCRIPTION OF THE EXAMPLE OF THE INVENTION ILLUSTRATED IN THE ATTACHED DRAWING

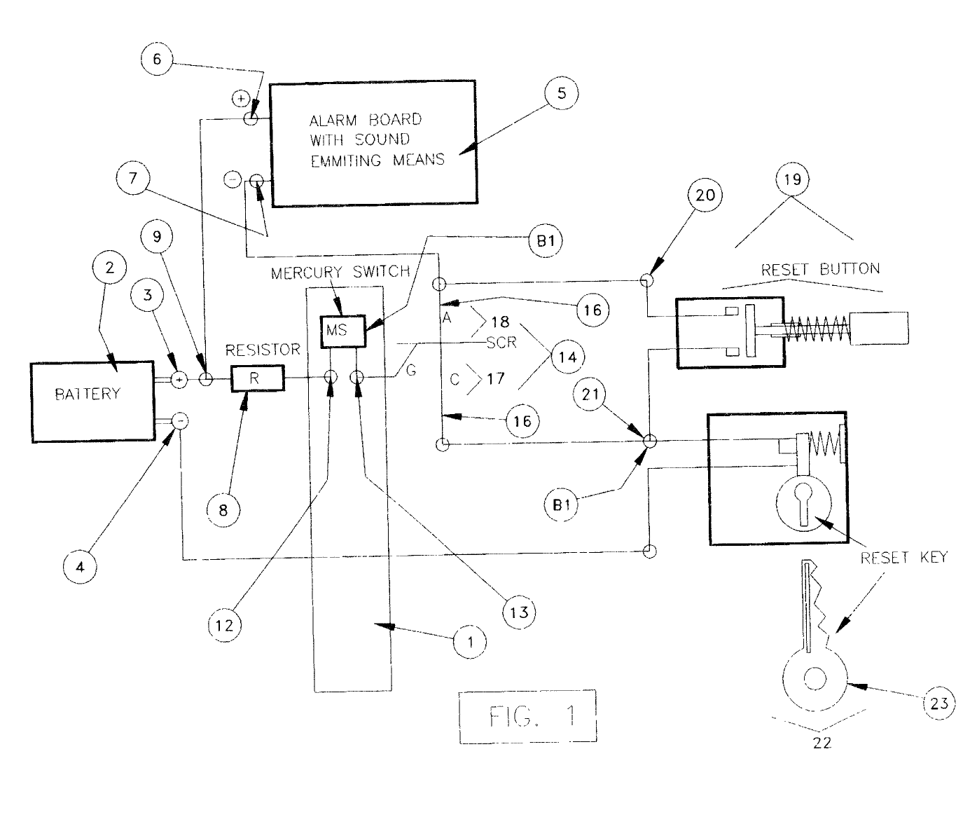

As is seen in the FIG. 1 the security system according with the application example of the invention is involving/comprising the following:

a valuable object/equipment 1;

an electric battery 2 having a plus terminal 3 and a minus terminal 4;

an alarm board 5 with high intensity sound emitting means having a plus connecting terminal 6 and a minus connecting terminal 7;

whereby the electric battery being compatible in terms of voltage with the alarm board,

a resistor 8 having a front end terminal 9 and a rear end terminal 10;

a normal open contact 11, in this case a mercury switch, having a front end terminal 12 and a rear end terminal 13, this normal open contact being hereinafter called the normal open motion detecting contact, this normal open contact being associated with means to detect the motion of the valuable object/equipment so that when the motion is happening the normal open contact is closing;

electrically/electronically latching means, in this case a SCR 14 able to latch or to keep closed a circuit if a latching signal is applied to it, having a latching command terminal 15 hereinafter called gate and two terminals 16 which are latched together to permit the passing of electric current, one being named hereinafter cathode 17 and the other being named hereinafter anode 18;

a normally open, manually operated spring pressed reset button 19 having a front end terminal 20 and a back end terminal 21;

a normally closed switch 22 able to be manually operated/opened by a dedicated security key 23 and having 2 terminals, one in the front 24 and one in the back 25;

whereby the plus terminal of the battery being connected to the plus terminal of the alarm board with the sound emitting means;

whereby the front terminal of the resistor being connected with the plus terminal of the battery and the back terminal of the resistor being connected with the front end terminal of the means to detect the motion of the valuable object;

whereby the back terminal of the means to detect the motion of the valuable object being conecded with the gate terminal of the latching means;

whereby the anode terminal of the latching means being connected with the negative terminal of the alarm board and with the front terminal of the reset button;

whereby the cathode terminal of the latching means being connected with the back terminal of the reset button and with the front terminal of the reset key;

whereby the back terminal of the reset key being connected with the minus terminal of the battery;

whereby all the above comprised or involved objects or at least the motion sensing means being rigidly affixed to the valuable object or structures rigidly associated with it like protection cases or the like.

The way of operation of the above described system being as follows:

In the moment when the motion sensing means-that is the mercury switch is detecting the motion of the valuable object, then the normally open contact associated with the motion sensing means that is with the mercury switch is closed, and a latching signal is given via the gate to the latching circuit (the SCR) making the current to go from cathode to anode in a latching mode—at that moment, the alarm board with sound emitting means will be activated and a piercing noise will be generated—because the system is latched by the latching system that is by the SCR; in this way the alarm will sound as long as the battery will last—usually cca 9 hours—enough to deter any perpetrator to go away with the valuable object or equipment; the system could be delatched when the security key is activated to open its normally closed contact; at that moment the system is practically rearmed for the next motion occurrence; the normally open reset button is used to check the battery and the system in general.

The advantage of the invention is simplicity permitting a distributed on valuable object security structure for deterring or interdicting any move of the protected valuable object, creating an unforgiving environment for criminals. Can be applied to computer equipment, art collections and in any other place requiring interdiction of movement for valuable objects or equipment.

The embodiments of the invention in which an exclusive property or/and privilege under the laws is claimed are defined as follows:

1. Security system comprising/involving:
a valuable object/equipment;
an electric battery having a plus terminal and a minus terminal;
an alarm board with high intensity sound emitting means having a plus connecting terminal and a minus connecting terminal;
whereby the electric battery being compatible in terms of voltage with the alarm board;
a resistor having a front end terminal and a rear end terminal;
a normal open contact having a front end terminal and a rear end terminal, this normal open contact being hereinafter called the normal open motion detecting contact, this normal open contact being associated with means to detect the motion of the valuable object/equipment so that when the motion is happening the normal open contact is closing;
electrically/electronically latching means able to latch or to keep closed a circuit if a latching signal is applied to it, having a latching command terminal hereinafter called gate and two terminals which are latched together to permit the passing of electric current, one being named hereinafter cathode and the other being named hereinafter anode;
a normally open, manually operated spring pressed reset button having a front end terminal and a back end terminal;
a normally closed switch able to be manually operated/opened by a dedicated security key and having 2 terminals, one in the front and one in the back;
whereby the plus terminal of the battery being connected to the plus terminal of the alarm board with the sound emitting means;
whereby the front terminal of the resistor being connected with the plus terminal of the battery and the back terminal of the resistor being connected with the front end terminal of the means to detect the motion of the valuable object;
whereby the back terminal of the means to detect the motion of the valuable object being connected with the gate terminal of the latching means;
whereby the anode terminal of the latching means being connected with the negative terminal of the alarm board and with the front terminal of the reset button;
whereby the cathode terminal of the latching means being connected with the back terminal of the reset button and with the front terminal of the reset key;
whereby the back terminal of the reset key being connected with the minus terminal of the battery;
whereby all the above comprised or involved objects or at least the motion sensing means being rigidly affixed to the valuable object or structures rigidly associated with it like protection cases or the like;

2. Security system as in claim 1 involving/comprising the following:
a valuable object/equipment;
an electric battery having a plus terminal and a minus terminal;
an alarm board with high intensity sound emitting means having a plus connecting terminal and a minus connecting terminal;
whereby the electric battery being compatible in terms of voltage with the alarm board;
a resistor having a front end terminal and a rear end terminal;
a normal open contact, in this case a mercury switch, having a front end terminal and a rear end terminal, this normal open contact being hereinafter called the normal open motion detecting contact, this normal open contact being associated with means to detect the motion of the valuable object/equipment so that when the motion is happening the normal open contact is closing;
electrically/electronically latching means, in this case a SCR able to latch or to keep closed a circuit if a latching signal is applied to it, having a latching command terminal hereinafter called gate and two terminals which are latched together to permit the passing of electric current, one being named hereinafter cathode and the other being named hereinafter anode;
a normally open, manually operated spring pressed reset button having a front end terminal and a back end terminal;
a normally closed switch able to be manually operated/opened by a dedicated security key and having 2 terminals, one in the front and one in the back;
whereby the plus terminal of the battery being connected to the plus terminal of the alarm board with the sound emitting means;
whereby the front terminal of the resistor being connected with the plus terminal of the battery and the back terminal of the resistor being connected with the front end terminal of the means to detect the motion of the valuable object;
whereby the back terminal of the means to detect the motion of the valuable object being connected with the gate terminal of the latching means;
whereby the anode terminal of the latching means being connected with the negative terminal of the alarm board and with the front terminal of the reset button;
whereby the cathode terminal of the latching means being connected with the back terminal of the reset button and with the front terminal of the reset key;
whereby the back terminal of the reset key being connected with the minus terminal of the battery;
whereby all the above comprised or involved objects or at least the motion sensing means being rigidly affixed to the valuable object or structures rigidly associated with it like protection cases or the like;
